(19) United States
(12) Patent Application Publication
(10) Pub. No.: US 2002/0096897 A1
(43) Pub. Date: Jul. 25, 2002

(54) Expanding internal carpet roll gripping and pulling device

(76) Inventors: Mathis P. Comardo, Cypress, TX (US); Peter J. Seymour, Magnolia, TX (US)

Correspondence Address: JAMES L. JACKSON, ANDREWS, KURTH, MAYOR, DAY,, CALDWELL & KEETON, L.L.P., 700 LOUISIANA, SUITE 1900, HOUSTON, TX, 77002, US

(21) Appl. No.: 10/055,874

(22) Filed: Jan. 18, 2002

Related U.S. Application Data
(60) Provisional application No. 60/262,771, filed on Jan. 19, 2001.

(51) Int. Cl. B66C 1/56; B66C 1/54

(52) U.S. Cl. 294/95

(57) ABSTRACT

A handling mechanism for rolls of carpet having a tubular core about which the carpet is rolled includes a force-transmitting member in moveable relation with a pivot support. An expansion actuator is located on the force-transmitting member and is spaced from the pivot support and defines reaction surfaces. A plurality of expansion and gripping fingers are pivotally mounted to the pivot support and each have a core gripping element for gripping contact with the inner surface to the tubular core. The expansion and gripping fingers each have finger expansion actuation surfaces in contact with respective reaction surfaces of the expansion actuator member. Upon linear movement of the force transmitting member relative to said pivot support member by a pulling force the reaction surfaces of the expansion actuator member cause pivotal expansion of the expansion and gripping fingers for gripping the carpet core and permit the pulling force to move the carpet roll.

Applicants hereby claim the benefit of U.S. Provisional Application No. 60/262,771, filed on Jan. 19, 2001 by Mathis P. Comardo and Peter J. Seymore and entitled Expanding Internal Carpet Roll Gripping and Pulling Device, which Application is incorporated by reference herein for all purposes.

### BACKGROUND OF THE INVENTION

Field of the Invention

The present invention relates generally to apparatus for handling rolls of carpet for covering floors and other surfaces. More particularly, the present invention concerns an expanding gripping and pulling device which is intended for insertion into the tubular cores of rolls of carpet and which, upon application of a pulling force on a handling ring of the device, causes expansion of a plurality of gripping fingers which grip the internal wall surface of a carpet roll sufficiently to permit a force applied to the expanding gripping and pulling device for moving the carpet roll linearly. This expanding gripping and pulling device is also applicable for gripping other tubular elements as well.

Carpet and carpet padding, after its manufacture, is typically wound on tubular cores, such as heavy cardboard cores, for ease of handling and shipment. Rolls of carpet typically weigh several hundred pounds and at carpet plants and carpet wholesale and retail businesses, can be handled by fork-lift trucks having fork elements or lift elements that are dimensioned for inserting into the tubular core of a carpet roll. Such lift and handling trucks are typically used for loading carpet rolls into the covered trailers that are typically used for transportation of carpet rolls from carpet factories or wholesalers to retail establishments.

At times, especially at retail establishments, specially designed handling trucks may not be available. In such case, manual handling of heavy carpet rolls, weighing several hundred pounds must be accomplished manually or by using more conventional forklift type handling equipment. Truck trailers are often unloaded by hook devices that are connected to cable lines. A worker will typically crawl into the trailer to its front end and manually place a hook such that a portion of the hook enters the tubular core of a selected carpet roll. Thereafter, a pulling force is applied to the cable or line for pulling the selected carpet roll out of the trailer and onto other handling equipment. This operation is repeated until all of the carpet rolls have been removed from the trailer. Obviously, especially when a trailer is virtually full of carpet rolls, it is difficult for a worker to crawl along the carpet rolls to the front end of the trailer. Also, a trailer unloading operation of this nature can be dangerous to the worker, because the rolls may inadvertently shift within the trailer. It is desirable therefore to provide for efficient and safe, essentially manual unloading of carpet rolls from trailers and to provide a simple and efficient tool for such use. It is also desirable to provide a tool for pulling carpet rolls from trailers which does not require a worker to enter the trailer.

### SUMMARY OF THE INVENTION

A tool for removal of carpet rolls from trailers, according to the principles of the present invention, has an elongate force transmitting member in the form of a bolt having a pull ring and one end and a threaded opposite end. A pivot support plate has a central hole within which the bolt is linearly moveable and has a plurality of pivot slots or openings that are arranged symmetrically about the central opening. An expansion actuator plate is secured at the opposite end of the bolt member by a nut and washer assembly to permit the bolt to move the actuator plate when a pulling force is applied to the pull ring of the bolt. The expansion actuator plate defines a plurality of edge slots within which the edges of a plurality of pivotal expansion and gripping fingers are located. Pivotal ends of the expansion and gripping fingers are located in the pivot slots of the support and reaction plate and are secured for pivotal movement by pivot members. The edges of the pivotal expansion and gripping fingers are inclined in such manner that movement of the expansion actuator plate along the inclined cam edges by pulling force on the bolt causes pivotal movement of the expansion and gripping fingers, thus forcing hook-like projections at the ends of the fingers that engage into the inner surface of the core of a carpet roll. The greater the pulling force on the bolt, the greater the gripping engagement that is established by the gripping ends of the fingers. A resilient finger collapsing element, such as an annular O-ring or helical spring is received within notches of the outer edges of the pivotal expansion fingers and causes pivotal collapsing of the fingers to release gripping relation with the core of a carpet roll when the pulling force on the bolt is released.

In use, the carpet roll gripping and pulling device is inserted into the core of a carpet roll until the support and reaction plate engages the end of the core. In this position, as a pulling force is applied by a cable or line on the pull ring of the bolt, the fingers will be expanded into gripping relation within the core. As the pulling force increases the expansion actuator plate will react with the tapered inner edges of the fingers, causing the gripping force to be increased. The pulling force is increased to pull the carpet roll end-wise from the trailer. Afterwards, the pulling force is released and the urging force of the external resilient member causes the gripping fingers to relax and retract from the inner surface of the core of the carpet roll. When so released, the gripping and pulling device can simply be removed from the core.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an elevational view showing the preferred embodiment of the present invention, with the device shown in the collapsed condition, such as for insertion thereof into the bore of a tubular core of a carpet roll;

FIG. 2 is an elevational view of one of the pivotally actuatable expanding and gripping fingers of the expanding gripping and pulling device of FIG. 1;

FIG. 3 is a plan view illustrating the pivot support plate of the expanding gripping and pulling device of FIG. 1;

FIG. 4 is an elevational view showing the pivot support plate of the expanding gripping and pulling device of FIGS. 1 and 3;

FIG. 5 is a plan view showing the expansion actuator plate of FIG. 1;

FIG. 6 is an elevational view showing an expandable and contractible carpet roll core gripping and pulling device representing an alternative embodiment of the present invention, the device being shown in the collapsed condition for insertion into the bore of the core of a carpet roll or other object;

FIG. 7 is an elevational view of one of the pivotally actuatable expanding and gripping fingers of the expanding gripping and pulling device of FIG. 6;

FIG. 8 is a plan view illustrating the pivot support plate of the expanding gripping and pulling device of FIG. 1;

FIG. 9 is a side elevation view illustrating the pivot support plate of the expanding gripping and pulling device of FIG. 6;

FIG. 10 is a plan view showing the pivotal finger actuation plate of the expanding gripping and pulling device of FIGS. 6 and 8;

FIG. 11 is a side elevation view showing the pivotal finger actuation plate of FIG. 10.

FIG. 12 is an elevational view showing an expandable and contractible carpet roll core gripping and pulling device representing another alternative embodiment of the present invention, the device being shown in the collapsed condition for insertion into the bore of the core of a carpet roll or other object;

FIG. 13 is an elevational view of one of the pivotally actuatable expanding and gripping fingers of the expanding gripping and pulling device of FIG. 12; and

FIG. 14 is a plan view showing the pivotal finger actuation plate of the expanding gripping and pulling device of FIGS. 12 and 13.

### DETAILED DESCRIPTION OF PREFERRED EMBODIMENT

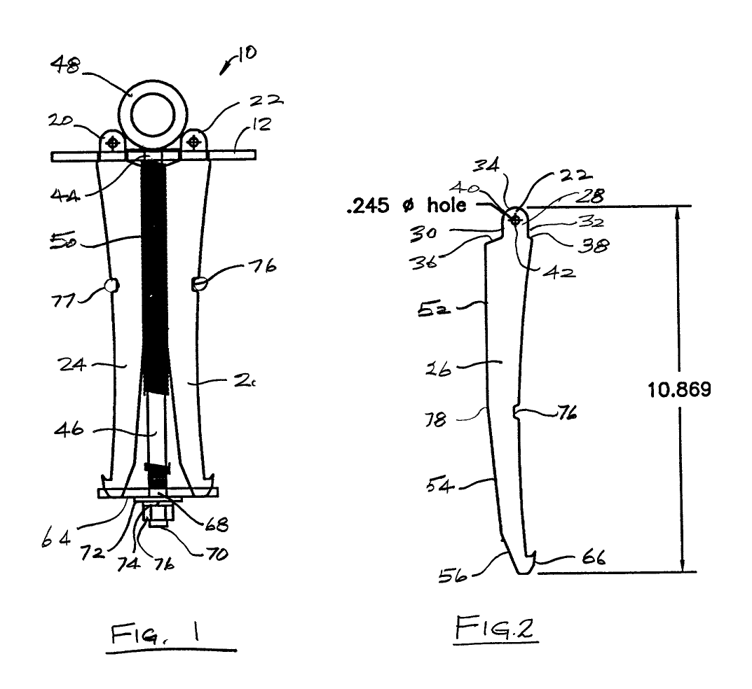

Referring now to the drawings and first to FIGS. 1-5 a preferred embodiment of the present invention is shown which comprises an expandable and contractible gripping and pulling device shown generally at 10. The gripping and pulling device 10 is adaptive particularly for insertion into the tubular, typically cardboard core of a roll of carpet and is expanded to establish gripping relation with the inner surface of the tubular core to thus permit the roll of carpet to be pulled linearly, such as for removing the carpet roll from a delivery vehicle. It should be borne in mind that the gripping and pulling device, though designed particularly for pulling carpet rolls, is applicable for gripping and pulling any other object having a bore into which the gripping and pulling device may be inserted and expanded. For purposes of simplicity, however, the present invention is discussed herein particularly as it relates to gripping and pulling carpet rolls.

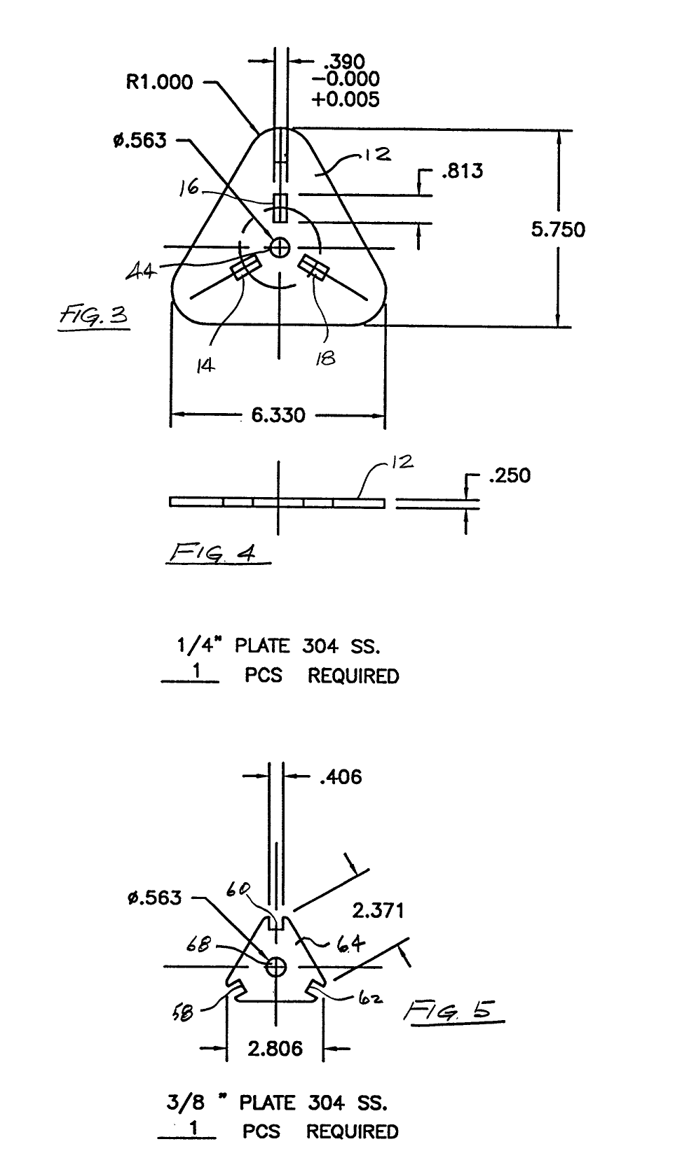

The gripping and pulling device 10 incorporates a pivot support and force reaction plate or member 12 which is shown by way of plan view in FIG. 3 and by way of side elevation view in FIG. 4. The pivot support and force reaction member 12, though conveniently taking the form of a plate member, may also have any other suitable structural form to provide for pivotal support of expandable and contractible finger elements and to provide for reaction of forces as a pulling force is being applied to the device 10 for gripping and pulling a structure such as a carpet roll. The plate member 12 defines a plurality of generally rectangular openings 14, 16 and 18 as shown in FIG. 3 through which pivot ends such as shown at 20 and 22 of pivotally supported and moveable expanding and gripping fingers extend. Though only two expanding and gripping fingers 24 and 26 are shown in FIG. 1, it is to be understood that any suitable number of such fingers may be employed. A pivot end of an expanding and gripping finger will be present within each of the rectangular openings 14, 16 and 18 of the pivot support plate 12. The pivotally actuatable expanding and gripping fingers each take the form shown at 16 in FIG. 2 where the pivot end 22 thereof is in the form of a tab 28 having essentially parallel side edges 30 and 32 that are spaced sufficiently to permit ease of insertion of the tab 28 within a respective rectangular opening of the pivot support plate 12. The tab 28 is also provided with a rounded end portion 34, which minimizes any potential for injury to a worker as the gripping and pulling device is handled. A pair of opposed angulated shoulders 36 and 38 extend from the respective side edges 30 and 32 and serve as stops to limit the extent to which the tab members of the fingers are moveable through the respective rectangular openings 14-18. The tabs 28 further define a centrally located pivot opening 40, through which a suitable pivot retainer element 42 such as a pin, bolt, screw, rivet or the like extends, to prevent the pivot ends of the pivotal expanding and gripping fingers from inadvertently separating from the respective rectangular pivot openings 14, 16 and 18 of the pivot support plate 12. The pivot retainer elements also support the respective finger elements so as to be essentially pivotally moveable with respect to the pivot support plate 12.

The pivot support and force reaction plate 12 also defines a central opening 44 through which extends an elongate force transmitting member 46 which may be in the form of a bolt member having a pulling ring 48 fixed to one end thereof. The handling ring, in addition to providing for connection of any suitable pulling element to the elongate force transmitting member, also serves a movement limiting function to maintain the elongate force transmitting member suitably positioned relative to the plate 12. The elongate force transmitting member is readily linearly moveable through the central opening 44 of the pivot support plate 12 as a pulling force is applied to the handling ring 48 by a chair, rope, etc. which is tied or otherwise connected to the handling ring.

Each of the pivotally actuatable expanding and gripping fingers 26 defines an upper internal edge section 52, which extends downwardly from the shoulder 36 is oriented relative to the pivot end tab 28 so as to lie in substantially parallel juxtaposed relation with the outer surface of the elongate force transmitting member 46 when the gripping and pulling device 10 is at the collapsed position shown in FIG. 1. Each of the expanding and gripping fingers 26 also defines an inclined internal edge section 54 which is disposed in slightly angulated relation with respect to the inside edge surface section 52 and which permits sections of the expanding and gripping fingers to be disposed in diverging relation with the elongate force transmitting element 46 as is also shown in FIG. 1. The lower terminal ends of each of the expanding and gripping fingers, as shown in FIG. 2, also defines an inclined cam edge surface 56, which is disposed for reaction with a respective actuating slot surface 58, 60 or 62 of an expansion actuator plate 64, which is shown in detail in FIG. 5. The inside edge surfaces 52, 54 and 56 define inside edge surfaces of compound angulated geometry on each of the expanding and gripping fingers 26 so that expansion movement of the fingers and the gripping force of the fingers differs during the various sections of linear movement of the elongate force transmitting member. Thus, the inside edge surfaces of the fingers provide the fingers with compound expansion and force applying movement during differing phases of expansion movement.

The terminal ends of the expanding and gripping fingers shown at 26 in FIG. 2 also define gripping elements for establishing gripping relation with the bore within which the apparatus is expanded. As shown, the gripping elements for the tubular cores of carpet rolls define outwardly projecting hook members 66 which are oriented to engage or bite into the internal surface of a core of a carpet roll to establish a gripping relationship therewith. It should be borne in mind that the hook-like gripping members may have any other suitable form or character or dimension having the capability of establishing sufficient gripping characteristics or frictional contact with the internal bore of the tube or core of a carpet roll or with any other suitable object so that linear force being applied to the pulling ring 48 by a pulling rope, cable, chain or the like will result in linear movement of the carpet roll or other device being pulled. With regard to safety, it is well known that stranded cables will stretch as force is being applied. In the event a cable should fail, an end of the broken cable can represent a danger to workers and equipment. It is advisable therefore, to ensure that the apparatus is utilized in a manner that is safe for workers and equipment.

The expansion actuator plate 64 also defines a central opening 68 as shown in FIG. 5 through which an end section 70 of the elongate force-transmitting element 46 extends. Typically, the end section 70 will be externally threaded and will receive a thrust washer 72, a lock washer 74, and a nut 76 to thus maintain the expansion actuator plate 64 in assembly with the elongate force transmitting element 46. The nut 76 is adjustable on the externally threaded end section 70 of the elements 46 to thereby permit the position of the expansion actuator plate 64 to be precisely oriented with respect to the terminal end sections of the respective pivotal expansion fingers 24-26.

Intermediate the extremities of each of the pivotally actuatable expanding and gripping fingers 24-26 the fingers each define externally oriented retainer recesses 76 so that contracting bands, garter springs or the like may be received by the recesses 76 of each of the fingers for the purpose of continuously applying a collapsing force for contracting the expanding and gripping fingers toward the collapsed positions thereof shown in FIG. 1 when the gripping force of the fingers is released. Relatively large O rings constructed of resilient or elastic material such as rubber or any other suitable elastomer material or a suitable spring member may also be located within the respective external recesses 76 for likewise contraction of the fingers when the expanding and gripping force thereof has been relaxed.

The expandable and contractible gripping and pulling device 10 is utilized by inserting it into the bore of a tubular element such as the core of a carpet roll and by application of a pulling force on the handling ring 48 of the elongate force transmitting element 46 while at the same time restraining the pivot support plate 12 against linear movement. As this occurs, the elongate force transmitting member 46 will be moved through the central opening 44 of the pivot support plate 12. As the elongate force transmitting member 46 is so moved, the expansion actuator plate 64 is moved linearly along with it. During such movement, the respective finger actuating slot surfaces 58, 60 and 62 will react against the compound inclined cam edge surfaces 56 of the respective gripping fingers 26 thereby causing the fingers to be pivoted about the respective pivots 42 thereof so that the pivot ends of the expanding and gripping fingers 26 are essentially rotated within the respective pivot slots 14, 16 and 18 of the pivot support plate 12. The rather severe inclination of the inclined cam edge surfaces 56 of the respective fingers 26 caused the fingers to be rapidly pivoted so that the respective gripping ends thereof move rapidly toward engagement with the internal surface of the bore or core of the carpet roll or other object being gripped for linear movement. After the expansion actuator plate 64 has moved sufficiently to clear the inclined cam edge surfaces 56 of the fingers, the less inclined diverging inside edge sections of the fingers 26 will be encountered by the respective finger actuating slot surfaces 58, 60 and 62. Thereafter, further linear movement of the elongate force transmitting member 46 and its expansion actuator plate 64 will cause outward pivotal movement of the expanding and gripping fingers 26 with enhanced radially outwardly directed force such that the terminal hook sections 66 of each of the fingers will bite into the inner surface portion of the carpet core or tube and establish an efficient gripping relationship between the gripping and pulling device 10 and the core of the carpet roll. Obviously, if the terminal hook sections 66 are replaced with any other suitable gripping device, this outwardly expanding pivotal movement of the respective pivotal expansion fingers 24-26 of the gripping and pulling device 10 will establish an appropriate gripping relationship with respect to the inner surface or bore of the object being gripped and pulled. As the pulling force on the handling ring 48 is increased, the gripping capability of the fingers 24-26 consequently increased as well, with the gripping force being controlled by the compound edge surfaces 52, 54 and 56 of the fingers. It is intended that the fingers be expanded to the maximum extent thereof before the expansion actuator plate 64 reaches the upper extent 78 of the diverging inside edges 54, so that traverse of the expansion actuator plate along the upper edge surface 52 will develop gripping force of sufficiently high magnitude for gripping and pulling a heavy object such as a carpet roll.

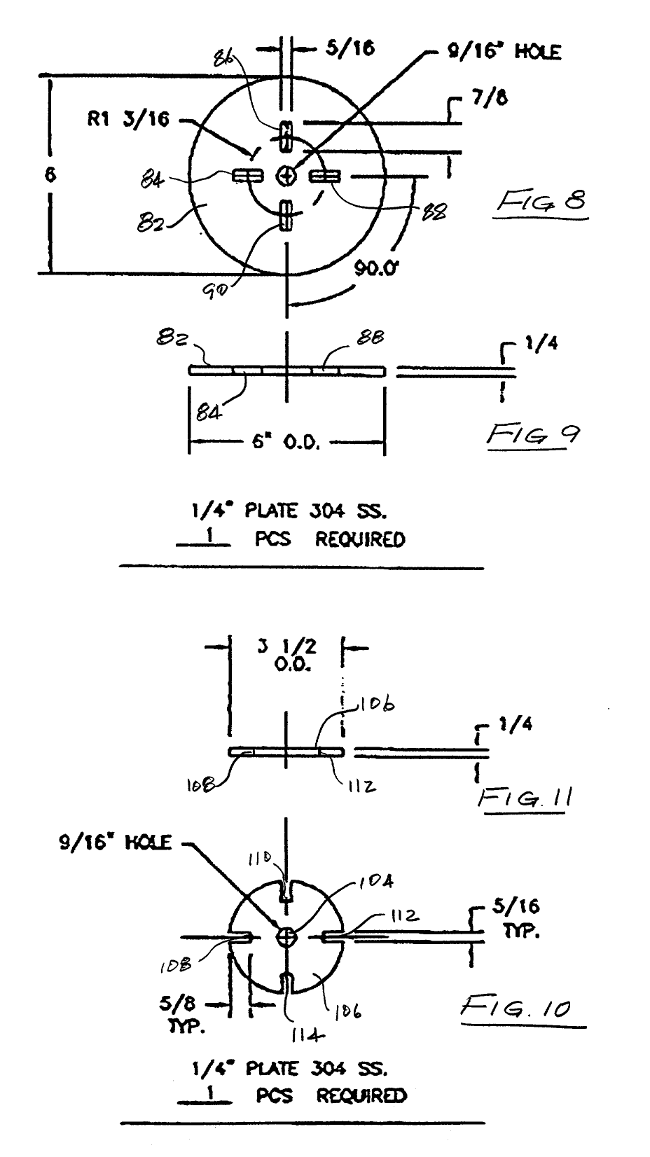

Referring now to FIGS. 6-11, an alternative embodiment of the present invention which is an expandable and contractible gripping and pulling device shown generally at 80. The device 80 incorporates a pivot support and force reaction plate 82 which is similar to that shown at 12 in FIG. 3, with the exception that the plate 82 is of circular configuration as shown in FIG. 8 rather than of triangular configuration as shown in FIG. 3. Also, the plate 82 defines four pivot openings 84, 86, 88 and 90 through which extend the pivotal end tabs 92 of four pivotal expansion and gripping fingers, two of which being shown at 94 and 96 in FIG. 6. The pivot tabs each have central openings which receive pivot retainer element 93-95 which secure the fingers in essentially pivotally supported and retained relation with the plate 82.

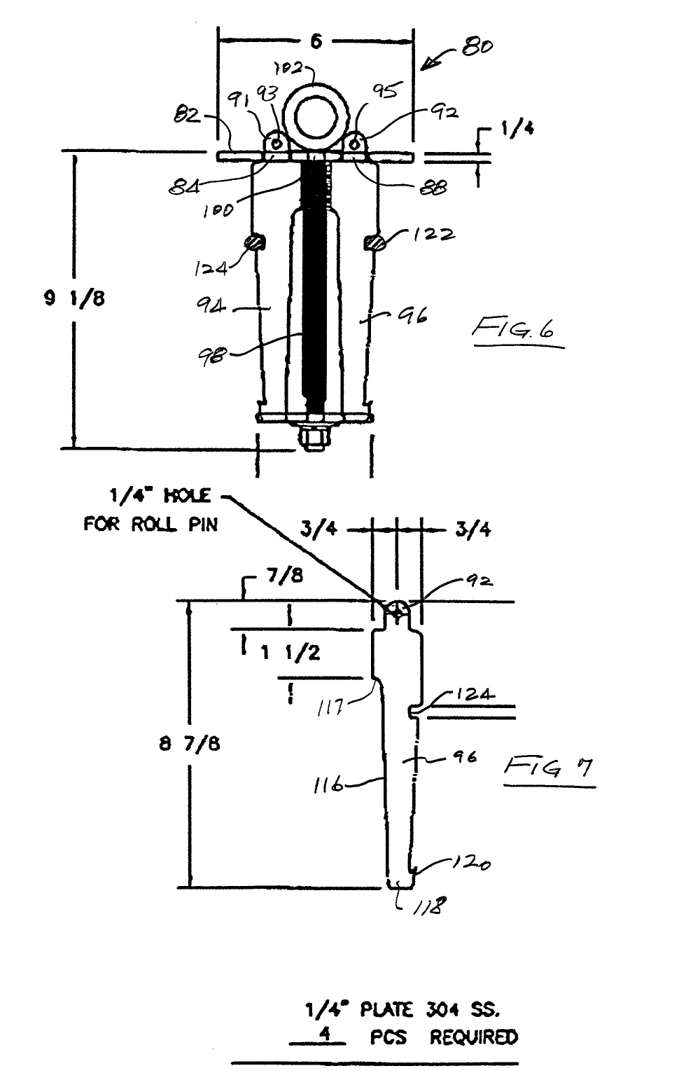

An elongated force transmitting member 98 extends through a central opening 100 of the pivot support and force reaction plate 82 and has a handling ring 102 fixed to the upper terminal end thereof. The lower end of the elongate force transmitting member 98 extends through a central opening 104 of an expansion actuator plate 106. The plate 106 also defines a plurality of finger actuating notches each defining respective finger actuating notch surfaces 108, 110, 112 and 114, which receive end portions of the respective expansion and gripping fingers 94-96 as shown in FIG. 6. Each of the pivotal fingers defines a tapered inner edge surface 116 as shown in FIG. 7 being tapered or inclined from a rounded shoulder 117 to the lower gripping section 118. As the expansion actuator plate 106 is moved upwardly, as shown in FIG. 6, the slot surfaces thereof react with the tapered inner surface 116 of each of the fingers to thereby cause pivotal movement of the fingers about the pivot elements 93 and 95 so that he lower ends of the fingers move essentially radially outwardly so as to expand into gripping relation with the internal wall surface of a bore that is defined by a tubular core of a carpet roll or by any other object having a bore therein. The lower ends of the fingers 94-96 are provided with a gripping element 120, which, as shown in FIGS. 6 and 7 may conveniently take the form of a hook like structure having the capability of biting into the material of the core or other structure and establishing a secure gripping relationship therewith. Upward movement of the expansion actuator plate 106 is caused by application of a pulling force on the handling ring 102 of the elongate force transmitting member 98. This force may be applied via a rope, chain or any other suitable pulling element for safe and efficient actuation of the gripping and pulling device.

For collapsing of the gripping and pulling device 80 when pulling force is no longer needed, a resilient garter spring element 122 may be received within respective notches 124 of the respective fingers 94-96 so as to continuously apply a force tending to collapse the fingers to the position shown in FIG. 6. The garter spring element 122 may conveniently take the form of an elastomer O ring, a coil spring or any other device having spring characteristics.

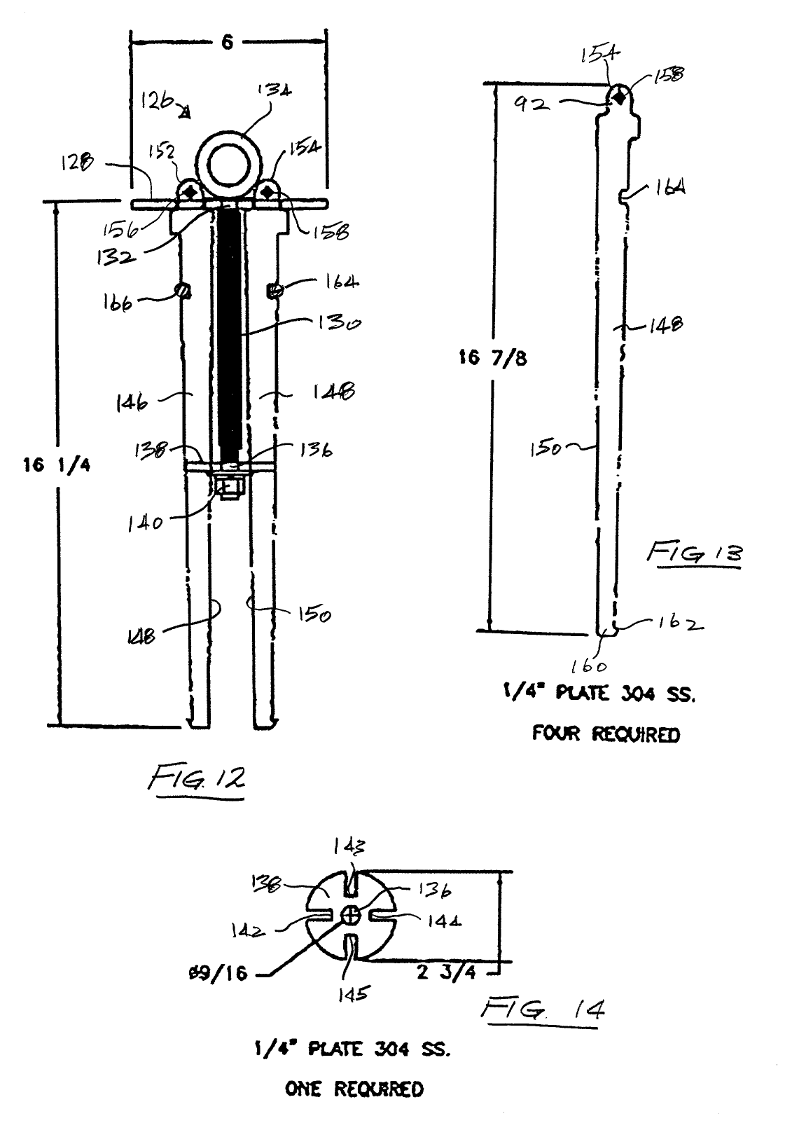

A further alternative embodiment of the present invention is shown generally at 126 of FIG. 12 and constitutes an expandable and contractible gripping and pulling device having a pivot support and force reaction plate 128, which may be of the same configuration and purpose as compared with the plate 82 of FIG. 8. An elongate force transmitting element 130 has an upper portion extending through the central aperture 132 of the plate 128 and is provided with a handling ring 134 at its upper end. A lower end section of the elongate force transmitting member extends through a central opening 136 of an expansion actuator plate 138, which may be of the configuration shown in FIG. 14. The plate 138 is retained in assembly with the elongate force transmitting member 130 by a washer and nut assembly 140. The plate 138 also defines a plurality of finger actuating slots, four in this case, each having finger actuating notch surfaces 142, 143, 144, and 145. These notches provide for orientation and expansion control of a plurality of pivotal expansion and gripping fingers 146 and 148. The respective notch surfaces 142-145 are disposed in actuating contact with respective inclined edge surfaces 148 and 150 of the respective expansion and gripping fingers. As the expansion actuator plate 138 moves upwardly as shown in FIG. 12, reaction of the notch surfaces 142-145 with the inclined surfaces 148 and 150 of the respective fingers will cause pivotal movement of the fingers so that the lower ends thereof move essentially radially outwardly into gripping relation with a bore of an object that is to be gripped and pulled. At their upper ends as shown in FIG. 12, the fingers 146-148 define tabs 152 and 154 that project through rectangular openings of the pivot support and force reaction plate 128 and are retained in assembly by the plate 128 by pivot members 156 and 158, which as indicated above, can conveniently take the form of pivot pins, bolts, rivets or any other suitable pivotal retainer devices.

At their lower ends, the fingers 146-148 define gripping sections 160, which may be in the form of hook-like gripping elements having a hook element 162 that engages and bites into the bore of a core member of a carpet roll or any other suitable object to be gripped and pulled. The gripping elements 162 may also conveniently take the form of frictional gripping elements depending upon the characteristics of the object to be gripped and pulled. The finger elements 146-148 also define spring retention slots 164, which face outwardly, thus permitting a garter spring element 166 to be retained therein for the purpose of collapsing the gripping and pulling device 126 to the condition shown in FIG. 12 in absence of an expansion force being applied by the elongate force transmitting element 130 through the finger actuation plate 138. Thus, as the plate 138 is moved upwardly as shown in FIG. 12, the fingers 146-148 will be pivoted relative to the pivot elements 156 and 158 thereby moving the lower ends of each of the fingers substantially radially outwardly for gripping within the bore of an object. This expansion force is applied by a rope, chain or any other device to the handling ring 134 thereby moving the elongate force transmitting member 130 relative to the plate 128. When collapsing movement of the fingers 146-148 is desired, the force on the handling ring 134 is relaxed and the force-transmitting element 130 is moved downwardly as shown in FIG. 12 thereby permitting pivotal collapsing movement of the fingers. To aid in collapsing movement of the fingers, a garter spring 166, which can conveniently take the form of an elastomer O ring, a metal garter spring or any other suitable spring device will pivot the fingers to the collapsed position shown in FIG. 12. This feature assists in releasing the gripping elements 162 from contact with the inner wall structure of the bore into which the pulling device is located.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

We claim:

1. A handling mechanism for rolls of carpet having a tubular core about which the carpet is rolled, comprising:
an elongate force transmitting member;
a pivot support member being located on said elongate force transmitting member;
an expansion actuator member being located on said elongate force transmitting member and being disposed in spaced relation with said pivot support and reaction member and defining a plurality of reaction surfaces;
a plurality of expansion and gripping fingers being pivotally mounted to said pivot support member and each having a core gripping element thereon, said plurality of expansion and gripping fingers each having finger expansion actuation surfaces disposed in contact with respective reaction surfaces of said expansion actuator member; and
upon linear movement of said elongate force transmitting member relative to said pivot support member said reaction surfaces of said expansion actuator member inducing pivotal expansion actuation of said expansion and gripping fingers and moving said core gripping elements into sufficient gripping relation with the inner surface of the core of the carpet roll that a pulling force can be applied to said elongate force transmitting member for moving the carpet roll.

2. The handling mechanism of claim 1, comprising:
each of said expansion and gripping fingers defining at least one expansion control surface having reaction engagement with a respective expansion actuation surface of said of said expansion actuator member, whereby said pulling force on said elongate force transmitting member is translated by said expansion actuation surfaces to core gripping forces of said core gripping elements.

3. The handling mechanism of claim 1, comprising:
said pivotal support having a central opening within which said elongate force transmitting member is linearly moveable; and
each of said expansion and gripping fingers having pivotal connection with said pivotal support.

4. The handling mechanism of claim 3, comprising:
said pivotal support having a slot for each of said expansion and gripping fingers;
said expansion and gripping fingers each having a pivot end extending through a respective one of said slots; and
a pivot element being received by each of said pivot ends of said expansion and gripping fingers and maintaining said expansion and gripping fingers in pivotal assembly with said pivotal support.

5. The handling mechanism of claim 1, comprising:
a force transmitting resilient member engaging each of said expansion and gripping fingers and upon release of expansion force applied by said elongate force transmitting member said force transmitting resilient member causing pivotal contraction movement of said expansion and gripping fingers away from gripping relation with the core of the carpet roll.

6. The handling mechanism of claim 5, comprising:
said expansion and gripping fingers each defining an external recess; and
said force transmitting resilient member being an annular resilient member engaged within each of said external recesses and providing a continuous urging force on each of said expansion and gripping fingers for pivotal contraction thereof away from the core of the carpet roll.

7. The handling mechanism of claim 1, comprising:
said pivotal support being of plate-like configuration defining a central opening and a plurality of pivot connections;
said force transmitting member being of elongate configuration having a portion thereof located within said central opening and having a pull ring fixed thereto and being of greater dimension than said central opening;
said plurality of expansion and gripping fingers each having pivotal support by said pivot connections; and
said expansion actuator member being of plate-like configuration and having a central opening within which a portion of said force transmitting member is located, said expansion actuator member being supported in spaced relation with said pivot support by a portion of said force transmitting member.

8. The handling mechanism of claim 1, comprising:
said pivotal support being a plate defining a central opening and a plurality of pivot openings;
said force transmitting member being a bolt member having a portion thereof located within said central opening and having a pull ring fixed at one end thereof and having a threaded section at a second end thereof;
said plurality of expansion and gripping fingers each having pivot elements being received by respective pivot openings;
pivot members securing each of said expansion and gripping fingers in pivotal connection with said pivotal support plate; and
said expansion actuator member being a plate having a central opening within which a portion of said force transmitting bolt member is located; and
a retainer nut member being connected to said threaded end of said bolt member and supporting said expansion actuator member in spaced relation with said pivot support plate.

9. The handling mechanism of claim 1, comprising:
said finger expansion actuation surfaces being inclined edge surfaces of said expansion and gripping fingers;
said expansion actuator member defining a plurality of finger actuator slots each receiving one of said expansion and gripping fingers having a bottom slot surface; and
said inclined edge of each of said expansion and gripping fingers having expansion actuation engagement with a respective inclined edge surface of a respective expansion and gripping finger.

10. The handling mechanism of claim 9, comprising:
said inclined edge of each of said expansion and gripping fingers being defined by at least two inclined edge segments each being disposed in angulated relation with one another and thus defining differing finger expansion movement and expansion force characteristics responsive to actuating engagement thereof with the respective bottom slots.

11. The handling mechanism of claim 1, comprising:
said core gripping element of each of said expansion and gripping fingers being a hook element capable of hooked engagement within the internal surface of the core of the carpet roll.

12. A handling mechanism for rolls of carpet having a tubular core about which the carpet is rolled, comprising:
an elongate force transmitting bolt having a pull ring defining a first thereof and having a threaded section defining a second end thereof;
a pivot support plate having a central opening within which said elongate force transmitting bolt is linearly moveable upon application of pulling force to said pull ring, said pivot support plate defining a plurality of pivot openings;
an expansion actuator plate having a central opening within which a portion of said elongate force transmitting bolt is located and defining a plurality of actuator slots each having a bottom slot surface;
a retainer nut being threaded to said threaded section of said force transmitting bolt and supporting said expansion actuator member on said force transmitting bolt; and
a plurality of expansion and gripping fingers being pivotally mounted to said pivot support plate member and each having a core gripping end, said plurality of expansion and gripping fingers each having a finger expansion actuation edge disposed within a respective actuator slot and having actuating contact with respective bottom slot surface of said expansion actuator member for pivotal expansion movement of said expansion and gripping fingers responsive to linear movement of said expansion actuator plate toward said pivot support plate by said force transmitting bolt.

13. The handling mechanism of claim 12, comprising:
said finger expansion edge of each of said expansion and gripping fingers being inclined; and
upward movement of said expansion actuator plate causing expansion reaction with said inclined finger expansion edge of each of said expansion and gripping fingers causing pivotal expansion of said expansion and gripping fingers and development of gripping force thereof with the inner surface of the core, the magnitude of gripping force being responsive to the magnitude of the pulling force.

14. The handling mechanism of claim 12, comprising:
said finger expansion actuation surfaces being inclined edge surfaces of said expansion and gripping fingers;
said expansion actuator member defining a plurality of finger actuator slots each receiving one of said expansion and gripping fingers having a bottom slot surface; and
said inclined edge of each of said expansion and gripping fingers having expansion actuation engagement with a respective inclined edge surface of a respective expansion and gripping finger.

15. The handling mechanism of claim 12, comprising:
said finger expansion actuation edge of each of said expansion and gripping fingers being defined by at least two inclined edge segments each being disposed in angulated relation with one another and thus defining differing finger expansion movement and expansion force characteristics responsive to actuating engagement thereof with the respective bottom slots.

16. The handling mechanism of claim 12, comprising:
outwardly facing slots being defined by each of said expansion and gripping fingers; and
an annular resilient element being received within each of said outwardly facing slots and continuously urging said expansion and gripping fingers toward the retracted positions thereof, upon release of the pulling force on said elongated force transmitting bolt, said annular resilient element pivotally moving said expansion and gripping fingers away from gripping relation with the core.

17. The handling mechanism of claim 12, comprising:
a force transmitting resilient member engaging each of said expansion and gripping fingers and upon release of expansion force applied by said elongate force transmitting member said force transmitting resilient member causing pivotal contraction movement of said expansion and gripping fingers away from gripping relation with the core of the carpet roll.

18. The handling mechanism of claim 12, comprising:
said plurality of expansion and gripping fingers each defining a pivot end extending through a respective one of said plurality of pivot openings of said pivot support plate and having a pivot aperture; and
a pivot member being located within each of said pivot apertures for securing said expansion and gripping fingers to said pivot support plate and establishing pivotal relation thereof with said pivot support plate.
